(19) United States
(12) Patent Application Publication
(10) Pub. No.: US 2026/0055941 A1
(43) Pub. Date: Feb. 26, 2026

(54) REFRIGERANT CIRCUIT UNIT

(71) Applicant: SANDEN CORPORATION, Isesaki-shi, Gunma (JP)

(72) Inventors: Shintaro FURUSHIMA, Isesaki-shi, Gunma (JP); Koji FUKUDA, Isesaki-shi, Gunma (JP); Tomomi KANO, Isesaki-shi, Gunma (JP)

(73) Assignee: SANDEN CORPORATION, Isesaki-shi, Gunma (JP)

(21) Appl. No.: 19/102,687

(22) PCT Filed: Jul. 27, 2023
(86) PCT No.: PCT/JP2023/027528

§ 371 Date: Feb. 10, 2025

(30) Foreign Application Priority Data
Aug. 24, 2022 (JP) 2022-133536

(51) Int. Cl. F25B 41/40; F25B 13/00

(52) U.S. Cl. CPC F25B 41/40; F25B 13/00

(57) ABSTRACT

A refrigerant circuit unit including: a refrigerant circuit including a compressor, a heater, an expansion mechanism, a cooler, and a channel module in which at least a part of a refrigerant channel that distributes a refrigerant circulated in the compressor, the heater, the expansion mechanism, and the cooler, is integrally formed; and a support plate that supports the refrigerant circuit. The channel module includes a high-pressure side region provided with a high-pressure channel through which a high-pressure refrigerant flows, a low-pressure side region provided with a low-pressure channel through which a low-pressure refrigerant flows, and a partition provided between the high-pressure side region and the low-pressure side region to separate the high-pressure side region and the low-pressure side region.

### TECHNICAL FIELD

The present invention relates to a refrigerant circuit unit that performs heat exchange between a refrigerant and another heating medium.

### BACKGROUND ART

Heretofore, there has been known a small refrigerant circuit unit in which devices (compressor, condenser, evaporator, expansion valve, refrigerant pipe, and the like) constituting a refrigerant circuit are fixed to a plate or the like and integrated.

As such a small refrigerant circuit unit, for example, Patent Literature 1 discloses a module in which devices constituting a refrigerant circuit such as a compressor, a heat exchanger, and an expansion valve are fixed to a channel plate having a manifold structure in which a plurality of refrigerant channels is integrally formed.

### CITATION LIST

### Patent Literature

Patent Literature 1: WO 2021/480951 A

### SUMMARY OF INVENTION

### Problems to be Solved by Invention

The plurality of refrigerant channels formed in the channel plate having the manifold structure described above includes a channel through which a high-pressure refrigerant flows and a channel through which a low-pressure refrigerant flows. For this reason, in the same metal body plate, a heat loss occurs due to heat transfer between a high-temperature region around the channel through which the high-pressure refrigerant flows and a low-temperature region around the channel through which the low-pressure refrigerant flows, and the system efficiency of the refrigerant circuit decreases.

The present invention has been made in view of such circumstances, and an object of the present invention is to reduce a heat loss generated between a channel through which a high-pressure refrigerant flows and a channel through which a low-pressure refrigerant flows, and to improve the system efficiency of a refrigerant circuit.

### Solution to Problems

A refrigerant circuit unit according to an aspect of the present invention includes: a refrigerant circuit including a compressor, a heater, an expansion mechanism, a cooler, and a channel module in which at least a part of a refrigerant channel that distributes a refrigerant circulated in the compressor, the heater, the expansion mechanism, and the cooler, is integrally formed; and a support plate that supports the refrigerant circuit, in which the channel module includes a high-pressure side region provided with a high-pressure channel through which a high-pressure refrigerant flows, a low-pressure side region provided with a low-pressure channel through which a low-pressure refrigerant flows, and a partition that is provided between the high-pressure side region and the low-pressure side region to separate the high-pressure side region and the low-pressure side region.

### Effects of Invention

According to the present invention, it is possible to reduce a heat loss generated between the channel through which the high-pressure refrigerant flows and the channel through which the low-pressure refrigerant flows, and to improve the system efficiency of the refrigerant circuit.

### BRIEF DESCRIPTION OF DRAWINGS

FIG. 1 is a perspective view of a refrigerant circuit unit according to an embodiment of the present invention.

FIG. 2 is a perspective view of the refrigerant circuit unit according to the embodiment of the present invention.

FIG. 3 is a perspective view of a channel module applied to the refrigerant circuit unit according to the embodiment of the present invention.

FIG. 4 is a perspective view of the channel module applied to the refrigerant circuit unit according to the embodiment of the present invention.

FIG. 5 is a perspective view of a support plate applied to the refrigerant circuit unit according to the embodiment of the present invention.

### DESCRIPTION OF EMBODIMENTS

In the following, modes for carrying out the present invention will be described in detail with reference to the drawings. In the following description, the same reference signs denote portions of the same functions, and redundant descriptions in the drawings are appropriately omitted.

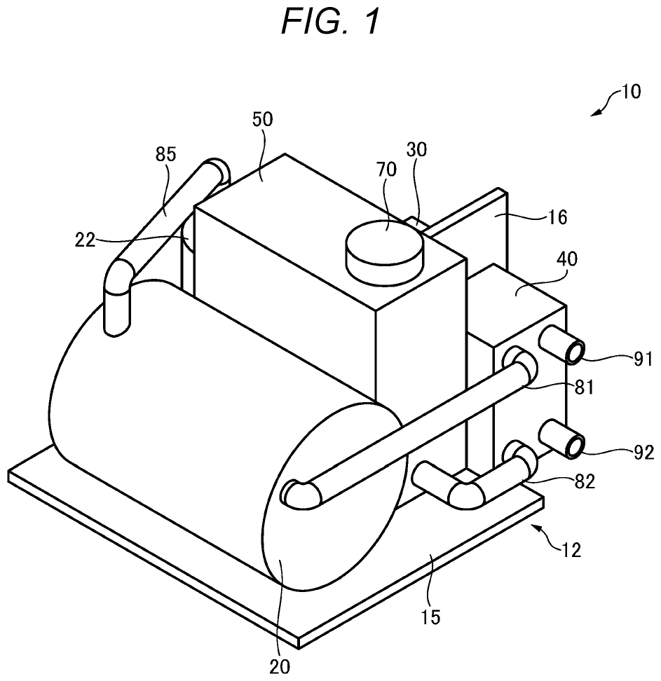

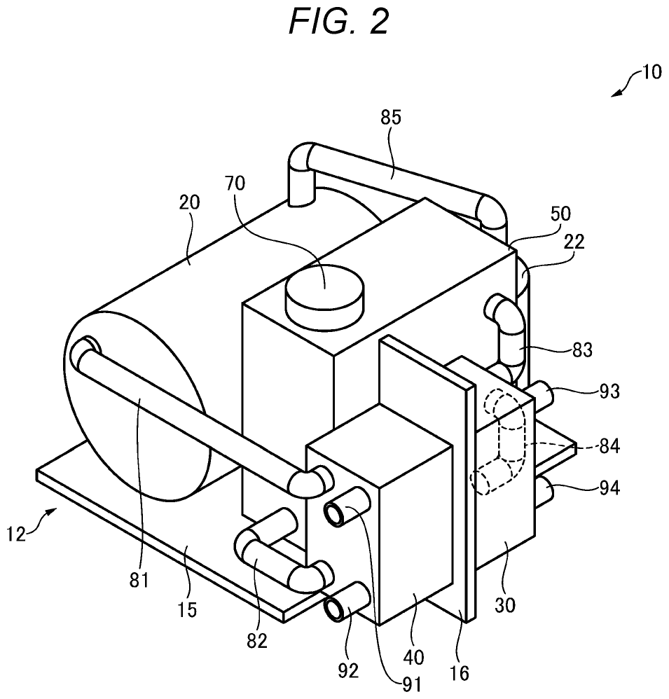

FIGS. 1 and 2 are perspective views of a refrigerant circuit unit 10 according to the present embodiment. The refrigerant circuit unit 10 according to the present embodiment is mounted on, for example, a vehicle including a traveling battery, and is used in an air conditioner or a heat management system that performs air conditioning in the vehicle interior, temperature adjustment of in-vehicle devices, and the like.

As shown in FIGS. 1 and 2, the refrigerant circuit unit 10 includes a refrigerant circuit in which a compressor 20, an accumulator 22, a cooler (evaporator) 30, a heater (condenser) 40, a channel module 50, and an expansion valve 70 are connected with refrigerant pipes 81 to 85, and a support plate 12 that supports these components.

Here, the cooler 30 and the heater 40 are refrigerant-heating medium heat exchangers that exchange heat between the refrigerant and the heating medium (for example, water), and perform air conditioning in the vehicle interior, temperature control of in-vehicle devices, and the like by supplying the heat of the refrigerant to a temperature control target via a heating medium circuit (not shown). In the example of FIGS. 1 and 2, the heating medium circulating in the heating medium circuit flows into the cooler 30 from the heating medium pipe 93, exchanges heat with the refrigerant in the cooler 30, and flows out to the heating medium pipe 94. Similarly, the heating medium circulating in the heating medium circuit flows into the heater 40 from the heating medium pipe 91, exchanges heat with the refrigerant in the heater 40, and flows out to the heating medium pipe 92.

FIG. 1 is a perspective view as viewed from the compressor 20 side, and FIG. 2 is a perspective view as viewed from the cooler 30 and the heater 40 side. As shown in FIGS. 1 and 2, in the refrigerant circuit unit 10, the compressor 20, the accumulator 22, the cooler 30, the heater 40, the channel module 50, and the expansion valve 70 constituting the refrigerant circuit are placed on a base plate 15 of the support plate 12.

Specifically, in the refrigerant circuit unit 10, the compressor 20 is disposed at one end on the base plate 15, the cooler 30 and the heater 40 are disposed at the other end, and the channel module 50 and the accumulator 22 are disposed between the compressor 20, and the cooler 30 and the heater 40. That is, in the refrigerant circuit unit 10 shown in FIGS. 1 and 2, the compressor 20 is disposed on one side and the cooler 30 and the heater 40 are disposed on the other side across the channel module 50 on the base plate 15. In the channel module 50, the expansion valve 70 is disposed on an upper surface on one end side, and the accumulator 22 is provided on a side surface on the other end side.

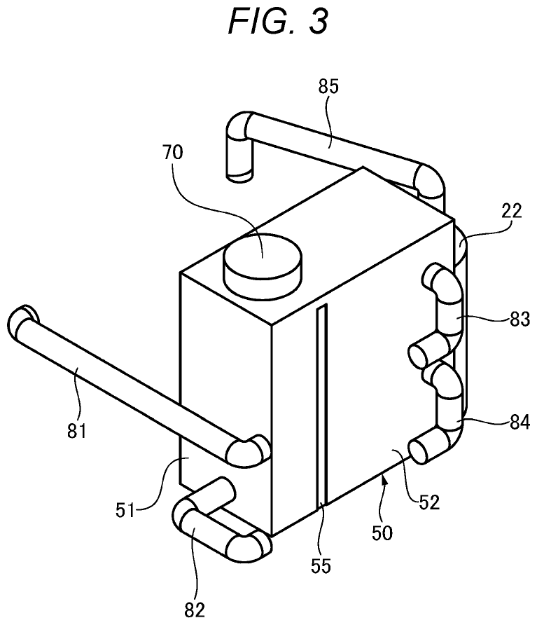

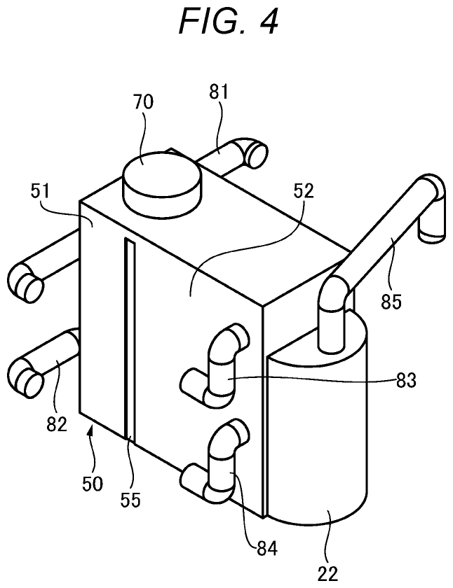

FIGS. 3 and 4 are perspective views of the channel module 50. The channel module 50 has a manifold structure in which a plurality of refrigerant channels is integrally formed inside a metal body, and constitutes at least a part of the channel through which the refrigerant circulates in the refrigerant circuit.

The refrigerant channel of the channel module 50 includes a high-pressure channel through which a high-pressure refrigerant flows and a low-pressure channel through which a low-pressure refrigerant flows. That is, in one metal body, a high-pressure channel that becomes high temperature and a low temperature channel that becomes low temperature due to the circulation of the refrigerant coexist.

Therefore, in the channel module 50, the high-pressure channels are disposed so as to be concentrated in a high-pressure side region 51, the low-pressure channels are disposed so as to be concentrated in a low-pressure side region 52, and the high-pressure side region 51 and the low-pressure side region 52 are further partitioned so as not to randomly mix the high-pressure channel that becomes high temperature and the low-pressure channel that becomes low temperature due to the circulation of the refrigerant.

That is, in one metal body, two regions of the high-pressure side region 51 having a high temperature and the low-pressure side region 52 having a low temperature due to circulation of a refrigerant are provided, and a slit 55 as a partition is provided between the high-pressure side region 51 and the low-pressure side region 52 so as to separate the high-pressure side region 51 from the low-pressure side region 52.

That is, the channel module 50 has the high-pressure side region 51 provided with the high-pressure channel and the low-pressure side region 52 provided with the low-pressure channel, and the high-pressure side region 51 and the low-pressure side region 52 are separated by the slit 55 as a partition. The slit 55 is provided between the high-pressure side region 51 and the low-pressure side region 52, and plays a role of suppressing heat transfer between the high-pressure side region 51 and the low-pressure side region 52. That is, in the channel module 50 which is a metal body, an air groove is formed by the slit 55 between the high-pressure side region 51 and the low-pressure side region 52, so that heat transfer between the high-pressure side region 51 and the low-pressure side region 52 is suppressed.

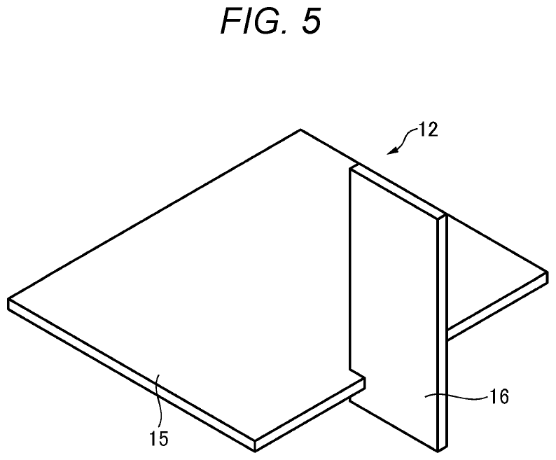

FIG. 5 is a perspective view showing the entire support plate 12. As shown in FIG. 5, the support plate 12 includes a base plate 15 and a heat exchanger support plate 16.

The compressor 20, the accumulator 22, the cooler 30, the heater 40, the channel module 50, and the expansion valve 70 constituting the refrigerant circuit are placed and fixed on the base plate 15.

The heat exchanger support plate 16 engages with the side portion of the base plate 15 such that the side portion of the heat exchanger support plate is perpendicular to the side portion of the base plate 15, supports the cooler 30 on one side surface of the heat exchanger support plate 16, and supports the heater 40 on the other side surface. A part of the heat exchanger support plate 16 is inserted into the slit 55.

This facilitates the positioning of the channel module 50, the cooler 30, and the heater 40 in the refrigerant circuit unit 10, and improves the ease of assembly of the refrigerant circuit unit 10.

In such a refrigerant circuit unit 10, the refrigerant circulates as follows.

That is, the refrigerant is compressed by the compressor 20 and discharged as a high-pressure gas refrigerant. The high-pressure gas refrigerant compressed in the compressor 20 flows into the heater 40 through the refrigerant pipe 81, radiates heat by exchanging heat with another heating medium in the heater 40, then flows out of the heater 40, and flows into the channel module 50 via the refrigerant pipe 82.

The refrigerant that has flowed into the channel module 50 passes through the high-pressure channel provided in the high-pressure side region 51 of the channel module 50 and flows into the expansion valve 70, and is decompressed and expanded by the expansion valve 70 to become a low-pressure refrigerant. The refrigerant having a low pressure in the expansion valve 70 passes through the low-pressure channel provided in the low-pressure side region of the channel module 50, then flows out of the channel module 50, passes through a refrigerant pipe 83, and flows into the cooler 30.

The low-pressure refrigerant flowing into the cooler 30 absorbs heat by exchanging heat with another heating medium in the cooler 30, then flows out of the cooler 30, passes through the low-pressure channel of the channel module 50, flows through the refrigerant pipe 84, flows into the accumulator 22, and returns from the accumulator 22 to the compressor 20 via the refrigerant pipe 85. The refrigerant flowing into the compressor 20 is compressed again, and the circulation is repeated.

When the refrigerant flows out of the condenser 40 and flows into the channel module 50 in the process of circulating the refrigerant as described above, the high-pressure refrigerant passes through the high-pressure channel, and the temperature of the high-pressure side region 51 rises. On the other hand, the low-pressure refrigerant having passed through the expansion valve 70 and decompressed passes through the low-pressure channel, and the temperature of the low-pressure side region 52 decreases. At this time, heat is transferred from the high-pressure side region 51 to the low-pressure side region 52, but since the slit 55 is provided and the air groove is formed, the high-pressure side region 51 and the low-pressure side region 52 are not continuous as metal bodies, and heat conduction from the high-pressure side region 51 to the low-pressure side region 52 is inhibited.

By forming the entire support plate 12 or at least the heat exchanger support plate 16 from a heat insulating material, the heat insulating material is inserted into the slit 55 as the partition, so that heat transfer between the high-pressure side region 51 and the low-pressure side region 52 can be further suppressed.

In this way, it is possible to reduce a heat loss generated between the channel through which the high-pressure refrigerant flows and the channel through which the low-pressure refrigerant flows, and it is possible to improve the system efficiency of the refrigerant circuit.

Although the embodiment of the present invention has been described above in detail with reference to the drawings, the specific configuration is not limited to the above-described embodiment, and modifications and the like in design without deviating from the gist of the present invention are also included in the present invention.

### LIST OF REFERENCE SIGNS

10 Refrigerant circuit unit
12 Support plate
15 Base plate
16 Heat exchanger support plate
20 Compressor
22 Accumulator
30 Cooler
40 Heater
50 Channel module
51 High-pressure side region
52 Low-pressure side region
55 Slit
70 Expansion valve
81 to 85 Refrigerant pipe
91 to 94 Heating medium pipe

1. A refrigerant circuit unit comprising:
a refrigerant circuit including a compressor, a heater, an expansion mechanism, a cooler, and a channel module in which at least a part of a refrigerant channel that distributes a refrigerant circulated in the compressor, the heater, the expansion mechanism, and the cooler, is integrally formed; and
a support plate that supports the refrigerant circuit, wherein
the channel module includes
a high-pressure side region provided with a high-pressure channel through which a high-pressure refrigerant flows, a low-pressure side region provided with a low-pressure channel through which a low-pressure refrigerant flows, and a partition that is provided between the high-pressure side region and the low-pressure side region to separate the high-pressure side region and the low-pressure side region.

2. The refrigerant circuit unit according to claim 1, wherein the partition is a slit provided between the high-pressure side region and the low-pressure side region in the channel module.

3. The refrigerant circuit unit according to claim 2, wherein a part of the support plate is inserted into the slit.

4. The refrigerant circuit unit according to claim 3, wherein the support plate is made of a material having a heat insulating property.
